(19) United States
(12) Patent Application Publication
(10) Pub. No.: US 2022/0124107 A1
(43) Pub. Date: Apr. 21, 2022

(54) SYSTEMS AND METHODS FOR IMPLEMENTING AN EXTENSIBLE SYSTEM OF RECORD IN A MACHINE LEARNING-BASED DIGITAL THREAT MITIGATION PLATFORM

(71) Applicant: Sift Science, Inc., San Francisco, CA (US)

(72) Inventor: Brian Higgins, Standford, CA (US)

(21) Appl. No.: 17/497,820

(22) Filed: Oct. 8, 2021

Related U.S. Application Data
(60) Provisional application No. 63/092,324, filed on Oct. 15, 2020.
(60) Provisional application No. 63/185,021, filed on May 6, 2021.

(51) Int. Cl. H04L 29/06; G06N 20/20; G06F 9/54

(52) U.S. Cl. CPC H04L 63/1416; G06F 9/547; G06N 20/20

(57) ABSTRACT

A system and method for implementing an extensible webhook service of a system of record includes receiving API-based webhook criteria for configuring an extensible webhook control data structure within a system of record; encoding the extensible webhook control data structure based on the API-based webhook criteria, wherein the encoding includes: (A) setting a webhook launching condition defining a custom API call that, when received, causes (i) an automatic creation of a payload of data from data sources within a system of record and (ii) an execution of a webhook operation; and (B) setting the webhook operation that identifies a web-based destination for the payload of data and that, when executed, causes an automatic transmission of the payload of data from the system of record to the web-based destination; wherein the extensible webhook control data structure, once encoded, automatically controls an interchange of data between the system of record and distinct external entities.

### CROSS-REFERENCE TO RELATED APPLICATIONS

This application claims the benefit of U.S. Provisional Application No. 63/092,324, filed 15 Oct. 2020, and U.S. Provisional Application No. 63/185,021, filed 6 May 2021, which are incorporated in their entireties by this reference.

### TECHNICAL FIELD

This invention relates generally to the digital fraud and abuse field, and more specifically to a new and useful system and method for detecting digital fraud or digital abuse and evolving underlying machine learning models in the digital fraud and abuse field.

### BACKGROUND

The modern web and Internet enable entities to engage and perform an incalculable number of activities. Many of these activities involve user-to-user activities, user-to-business activities (or the reverse), and the like. These activities between users and between users and organizational entities over the web often involve the access, use, and/or exchange of information by one or more of the parties of the activities. Because of the malleable nature of the digital realm that these activities operate within, there arise a countless number of digital threats by digital actors that aim to commit digital fraud and/or digital abuse using online services and/or Internet-accessible applications (e.g., web or mobile applications). Additionally, some of these bad digital actors may also aim to misappropriate the information (e.g., hack) being exchanged between legitimate entities to these activities. These digital threats may also be perpetrated by malicious third parties who seek to unlawfully or otherwise, impermissibly take advantage of the data or information that is exchanged or, if not exchanged, data or information about the activities or actions of users and/or businesses on the web.

Other digital threats involving a malicious party or a bad digital actor that acts unilaterally (or in concert with other malicious actors) to abuse digital resources of a service provider to perpetrate fraud or other unlawful activities that are also of significant concern to legitimate service providers and users of the Internet.

While there may currently exist some technologies that attempt to detect digital fraud and digital abuse or other malicious digital activities over the Internet, these existing technology implementations may not sufficiently detect malicious digital activities over the Internet with accuracy and in real-time to provide an opportunity for an appropriate response by an affected party. Additionally, these existing technology implementations lack the capabilities to detect new and/or never been encountered before digital threats and automatically (or near automatically) evolve the technology implementation to effectively respond and neutralize the digital threats.

Therefore, there is a need in the digital fraud and abuse field for a digital fraud and abuse solution that enables effective detection of multiple and specific digital threats involving digital fraud and/or digital abuse via digital resources of a service provider. The embodiments of the present application described herein provide technical solutions that address, at least, the need described above.

### SUMMARY OF THE INVENTION(S)

In one embodiment, a method for implementing an extensible webhook service that intelligently enables a data management and access service includes receiving, via a web-based configuration interface, API-based webhook criteria for configuring an extensible webhook control data structure within a system of record, wherein the API-based webhook criteria includes: (1) webhook launching criteria that define one or more conditions for automatically causing an execution of one or more webhook operations; and (2) webhook operation criteria that define one or more payloads of data desired for one or more webhook destinations; encoding the extensible webhook control data structure based on the API-based webhook criteria, wherein the encoding includes: (A) setting a webhook launching condition defining a custom API call that, when received, causes (i) an automatic creation of a payload of data from data sources within a data management and access service and (ii) an execution of a webhook operation; and (B) setting the webhook operation that identifies a web-based destination for the payload of data and that, when executed, causes an automatic transmission of the payload of data from the data management and access service to the web-based destination; wherein the extensible webhook control data structure, once encoded, automatically controls an interchange of data between the data management and access service and a plurality of distinct external entities.

In one embodiment, the extensible webhook control data structure includes (1) a plurality of distinct webhook launching conditions defined based on a plurality of distinct webhook launching criteria, wherein each of the plurality of distinct webhook launching conditions being enumerated along one of a plurality of distinct entries of the extensible webhook control data structure; and (2) a plurality of distinct webhook operations defined based on a plurality of distinct webhook operations criteria, wherein each of the plurality of distinct webhook operations being enumerated along one of the plurality of distinct entries in association with one of the plurality of distinct webhook launching conditions.

In one embodiment, the webhook launching condition defining the custom API call comprises a unique API parameter that, when received, causes an automatic lookup into the extensible webhook control data structure.

In one embodiment, the automatic lookup based on the unique API parameter identifies a target automated webhook workflow that is associated with the unique API parameter within the extensible webhook control data structure.

In one embodiment, the automated webhook workflow includes instructions that, when executed, causes: an automatic creation of the payload of data; an identification of the webhook destination for the payload of data; and an automatic transmission of the payload of data to the webhook destination.

In one embodiment, the data management and access service include one or more corpora of data sourced from activities involving the plurality of external entities.

In one embodiment, the web-based configuration interface is in operable communication with a webhook service of the data management and access service that creates entries into the extensible webhook control data structure based on the API-based webhook criteria.

In one embodiment, the extensible webhook control data structure controls an initialization of a payload service and a webhook service, wherein: the payload service automatically creates the payload of data and communicates the payload of data to a webhook service, and the webhook service identifies the webhook destination of the payload of data and automatically transmits the payload of data to the webhook destination.

In one embodiment, the extensible webhook control data structure includes a digital mapping between each of a plurality of distinct webhook launching conditions to one of a plurality of distinct payload creation operations and associated one of a plurality of distinct webhook operations.

In one embodiment, the encoding the extensible webhook control data structure based on the API-based webhook criteria includes: establishing an executional nexus between the webhook launching condition and the webhook operation enabling an automated execution of the webhook operation on a basis of satisfying the webhook launching condition.

In one embodiment, the webhook control data structure comprises: a first data structure having each of a plurality of distinct webhook launching conditions, and a second data structure having each of a plurality of distinct webhook operations.

In one embodiment, the encoding the extensible webhook control data structure based on the API-based webhook criteria includes: configuring an executional nexus between the first data structure and the second data structure, wherein the executional nexus includes a reference pointer that points to an entry in the second data structure based on a satisfaction of a distinct webhook launching condition of the first data structure.

In one embodiment, the extensible webhook control data structure, once encoded, controls a webhook API service, wherein the webhook API service is implemented by one or more API computing servers that interface with a plurality of distinct databases of the data management and access service.

In one embodiment, a method for implementing an extensible webhook service that intelligently enables a system of record includes receiving, via a web-based configuration interface, API-based webhook criteria for configuring an extensible webhook control data structure within a system of record, wherein the API-based webhook criteria includes: (1) webhook launching criteria that define one or more conditions for automatically causing an execution of one or more webhook operations; and (2) webhook operation criteria that define one or more payloads of data desired for one or more webhook destinations; encoding the extensible webhook control data structure based on the API-based webhook criteria, wherein the encoding includes: (A) setting a webhook launching condition defining a custom API call that, when received, causes (i) an automatic creation of a payload of data from data sources within a system of record and (ii) an execution of a webhook operation; and (B) setting the webhook operation that identifies a web-based destination for the payload of data and that, when executed, causes an automatic transmission of the payload of data from the system of record to the web-based destination; wherein the extensible webhook control data structure, once encoded, automatically controls an interchange of data between the system of record and a plurality of distinct external entities.

In one embodiment, the extensible webhook control data structure comprises: (1) a plurality of distinct webhook launching conditions defined based on a plurality of distinct webhook launching criteria, wherein each of the plurality of distinct webhook launching conditions being enumerated along one of a plurality of distinct entries of the extensible webhook control data structure; and (2) a plurality of distinct webhook operations defined based on a plurality of distinct webhook operations criteria, wherein each of the plurality of distinct webhook operations being enumerated along one of the plurality of distinct entries in association with one of the plurality of distinct webhook launching conditions.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application; and

FIG. 3 illustrates an example schematic for implementing portions of the method 200 and system 100 in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

Overview

As discussed above, digital threats are abounding and continue to evolve to circumvent existing digital fraud detection technologies. The evolving nature of digital threats compounded with the great number of transactions, events, actions, and/or activities (exceeding billions in number) occurring over the web and/or Internet highlight the many deficiencies of traditional digital fraud detection and threat mitigation implementations.

The embodiments of the present application, however, provide an advanced technology platform that is capable of ingesting billions of digital events and/or transactions over the Internet, the web, web applications, mobile applications, and the like and dynamically implement digital threat mitigation implementations that are capable of detecting malicious activities, fraudulent activities, digital abuses and generate digital threat mitigation recommendations and responses that operate to mitigate and/or eliminate the digital fraud and abuse threats stemming from the malicious or fraudulent activities, as described in U.S. Pat. No. 9,954,879, which is incorporated herein in its entirety by this reference.

The advanced technology platform of many embodiments of the present application employs a robust ensemble of machine learning models and related systems that operate to ingest the great number of digital activities performed and events occurring over the web. Accordingly, using these finely tuned and perpetually evolving and tunable machine learning models, a system implementing the several embodiments of the present application can predict a threat level and/or classify a digital threat with high accuracy and, in some embodiments, in real-time (e.g., as the event is occurring or shortly thereafter) compute a digital threat score for each event or activity that is received by the system.

The digital threat score may be exposed via a score application program interface (API) that may function to interact with various endpoints of the digital threat mitigation platform. Specifically, the score API may function to interact with one or more computing servers that implement the ensembles of machine learning models used to predict a likelihood of digital fraud and/or digital abuse. The score API may function to return a value (e.g., a number, likelihood or probability, or other criterion) that indicates how likely it is that an actor involved or associated with digital events and/or activities is a malicious actor or may be perpetrating cyber fraud or digital abuse (e.g., payment abuse, etc.). Accordingly, the digital threat score calculated by the score API may be used in several manners including to inform digital event data processing decisions (e.g., deny, hold, or approve digital transaction) or to define which of one or more digital threat mitigation protocols or implementations that should be applied to future digital event data and/or current the digital events to mitigate or eliminate a digital threat associated therewith.

1. System for Digital Fraud and/or Abuse Detection and Scoring

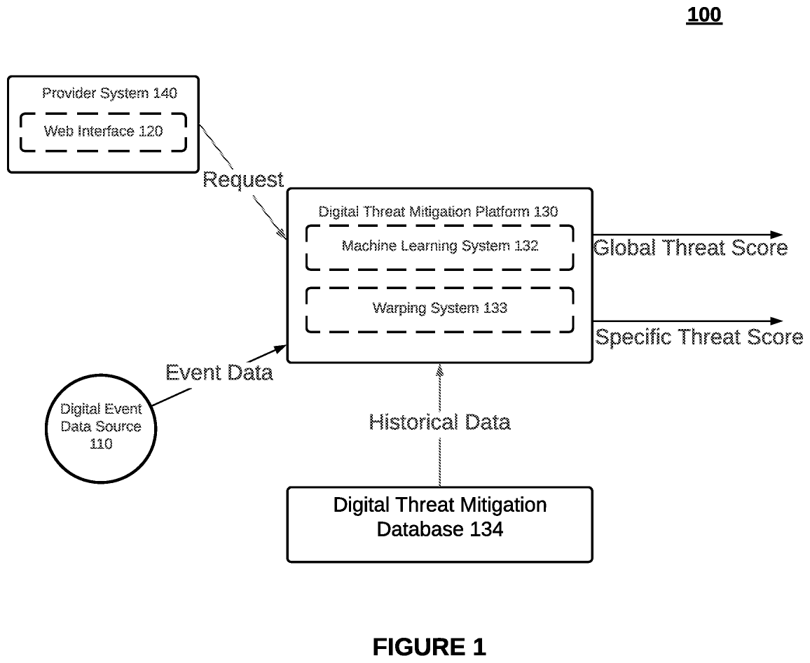

As shown in FIG. 1, a system 100 for detecting digital fraud and/or digital abuse includes one or more digital event data sources 110, a web interface 120, a digital threat mitigation platform 130, and a service provider system 140.

The system 100 functions to enable a prediction of multiple types of digital abuse and/or digital fraud within a single stream of digital event data. The system 100 provides web interface 120 that enables subscribers to and/or customers of a threat mitigation service implementing the system 100 to generate a request for a global digital threat score and additionally, make a request for specific digital threat scores for varying digital abuse types. After or contemporaneously with receiving a request from the web interface 120, the system 100 may function to collect digital event data from the one or more digital event data sources no. The system 100 using the digital threat mitigation platform 130 functions to generate a global digital threat score and one or more specific digital threat scores for one or more digital abuse types that may exist in the collected digital event data.

The one or more digital event data sources 110 function as sources of digital events data and digital activities data, occurring fully or in part over the Internet, the web, mobile applications, and the like. The one or more digital event data sources 110 may include a plurality of web servers and/or one or more data repositories associated with a plurality of service providers. Accordingly, the one or more digital event data sources no may also include the service provider system 140.

The one or more digital event data sources no function to capture and/or record any digital activities and/or digital events occurring over the Internet, web, mobile applications (or other digital/Internet platforms) involving the web servers of the service providers and/or other digital resources (e.g., web pages, web transaction platforms, Internet-accessible data sources, web applications, etc.) of the service providers. The digital events data and digital activities data collected by the one or more digital event data sources 110 may function as input data sources for a machine learning system 132 of the digital threat mitigation platform 130.

The digital threat mitigation platform 130 functions as an engine that implement at least a machine learning system 132 and, in some embodiments, together with a warping system 133 to generate a global threat score and one or more specific digital threat scores for one or more digital abuse types. The digital threat mitigation platform 130 functions to interact with the web interface 120 to receive instructions and/or a digital request for predicting likelihoods of digital fraud and/or digital abuse within a provided dataset. The digital threat mitigation engine 130 may be implemented via one or more specifically configured web or private computing servers (or a distributed computing system) or any suitable system for implementing system 100 and/or method 200.

The machine learning system 132 functions to identify or classify features of the collected digital events data and digital activity data received from the one or more digital event data sources 110. The machine learning system 132 may be implemented by a plurality of computing servers (e.g., a combination of web servers and private servers) that implement one or more ensembles of machine learning models. The ensemble of machine learning models may include hundreds and/or thousands of machine learning models that work together to classify features of digital events data and namely, to classify or detect features that may indicate a possibility of fraud and/or abuse. The machine learning system 132 may additionally utilize the input from the one or more digital event data sources no and various other data sources (e.g., outputs of system 100, system 100 derived knowledge data, external entity-maintained data, etc.) to continuously improve or accurately tune weightings associated with features of the one or more of the machine learning models defining the ensembles.

The warping system 133 of the digital threat mitigation platform 130, in some embodiments, functions to warp a global digital threat score generated by a primary machine learning ensemble to generate one or more specific digital threat scores for one or more of the plurality of digital abuse types. In some embodiments, the warping system 133 may function to warp the primary machine learning ensemble, itself, to produce a secondary (or derivative) machine learning ensemble that functions to generate specific digital threat scores for the digital abuse and/or digital fraud types. Additionally, or alternatively, the warping system 130 may function to implement a companion machine learning model or a machine learning model that is assistive in determining whether a specific digital threat score should be generated for a subject digital events dataset being evaluated at the primary machine learning model. Additionally, or alternatively, the warping system 133 may function to implement a plurality of secondary machine learning models defining a second ensemble that may be used to selectively determine or generate specific digital threat scores. Accordingly, the warping system 133 may be implemented in various manners including in various combinations of the embodiments described above.

The digital threat mitigation database 134 includes one or more data repositories that function to store historical digital event data. The digital threat mitigation database 134 may be in operable communication with one or both of an events API and the machine learning system 132. For instance, the machine learning system 132 when generating global digital threat scores and specific digital threat scores for one or more specific digital abuse types may pull additional data from the digital threat mitigation database 134 that may be assistive in generating the digital threat scores.

The ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation form transformers (BERT) for masked language model tasks and next sentence prediction tasks and the like, variations of BERT (i.e., ULMFiT, XLM UDify, MT-DNN, SpanBERT, RoBERTa, XLNet, ERNIE, KnowBERT, VideoBERT, ERNIE BERT-wwm, GPT, GPT-2, GPT-3, ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

The service provider 140 functions to provide digital events data to the one or more digital event data processing components of the system 100. Preferably, the service provider 140 provides digital events data to an events application program interface (API) associated with the digital threat mitigation platform 130. The service provider 140 may be any entity or organization having a digital or online presence that enable users of the digital resources associated with the service provider's online presence to perform transactions, exchanges of data, perform one or more digital activities, and the like.

The service provider 140 may include one or more web or private computing servers and/or web or private computing devices. Preferably, the service provider 140 includes one or more client devices functioning to operate the web interface 120 to interact with and/or communication with the digital threat mitigation engine 130.

The web interface 120 functions to enable a client system or client device to operably interact with the remote digital threat mitigation platform 130 of the present application. The web interface 120 may include any suitable graphical frontend that can be accessed via a web browser using a computing device. The web interface 120 may function to provide an interface to provide requests to be used as inputs into the digital threat mitigation platform 130 for generating global digital threat scores and additionally, specific digital threat scores for one or more digital abuse types. Additionally, or alternatively, the web (client) interface 120 may be used to collect manual decisions with respect to a digital event processing decision, such as hold, deny, accept, additional review, and/or the like. In some embodiments, the web interface 120 includes an application program interface that is in operable communication with one or more of the computing servers or computing components of the digital threat mitigation platform 130.

The web interface 120 may be used by an entity or service provider to make any suitable request including requests to generate global digital threat scores and specific digital threat scores. In some embodiments, the web interface 120 comprises an application programming interface (API) client and/or a client browser.

### 2. Method for Implementing an Extensible Webhook Service

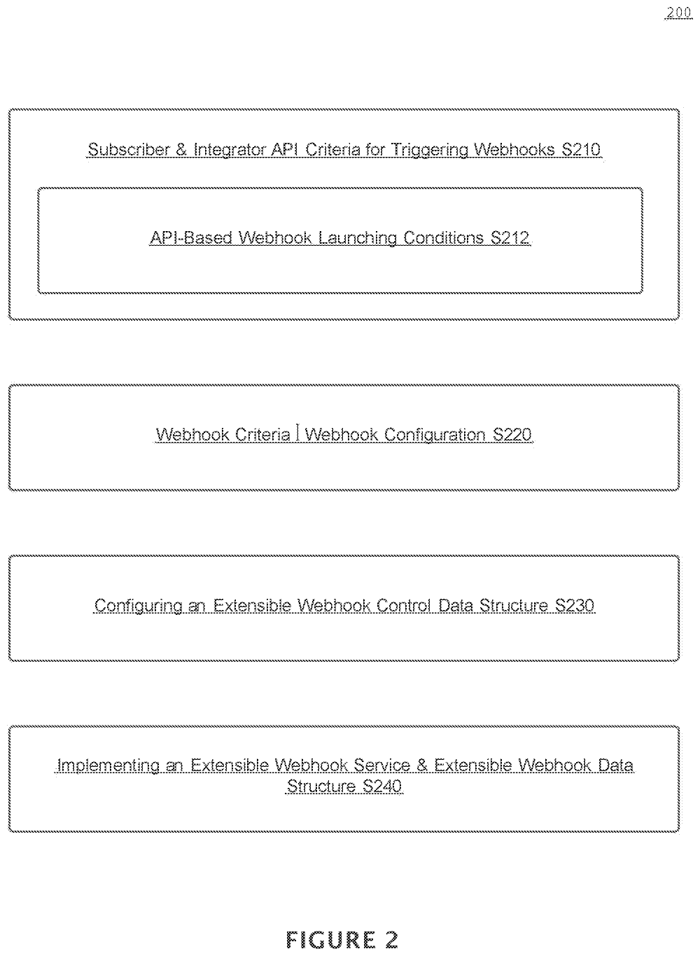

As shown in FIG. 2, the method 200 for implementing an extensible webhook service in a machine learning-based digital threat mitigation platform includes identifying a set of criteria for configuring one or more webhook launching conditions S210, configuring one or more webhook logic S220, configuring an extensible webhook control data structure S230, implementing an extensible webhook service of a system of record S240.

### 2.10 Subscriber & Integrator Criteria for Triggering Webhooks

S210, which includes identifying criteria for configuring or defining one or more webhook launching conditions, may function to obtain a set of criteria that may define launching conditions for automatically launching (e.g., triggering) or causing an execution of one or more webhook operations. In a preferred embodiment, the launching conditions for the one or more webhooks may be set within a system of record or the like that may function to maintain at least a first service that may be configured to identify and respond to webhook launching conditions and a second service (i.e., a webhook service) that may be configured to automatically execute webhooks and webhook operations (based on a launching signal from the first service). It shall be noted that a (webhook) launching condition, as referred to herein, preferably relates to a designated event and/or an occurrence that, when detected or satisfied, may function to cause an automated execution of one or more webhook operations.

The system of record, as referred to herein, preferably relates to a data management and access (DMA) service of or associated with a digital threat mitigation platform/service (e.g., system 100). In one or more embodiments, one or more services performed by the system of record may include, but should not be limited to, acquiring and maintaining digital threat data, online event data, chargeback data, and the like used in performing one or more machine learning-based assessments of digital threats or digital risks for one or more subscribers to the digital threat mitigation service. In a preferred embodiment, the system of record may function to collect, store, and/or facilitate access to subscriber data including, but not limited to, event and/or activity data relating to one or more target online events or activities, data derived from or computed based on the event and/or activity data (e.g., threat score data, etc.), data relating to one or more outcomes or results of the events, data relating to one or more outcomes or results based on implementing a computed digital threat mitigation proposal (e.g., block/disallow, hold, review, and/or the like), data relating to disputes between one or more of a subscriber, a customer, and a third-party service provider (e.g., chargeback management provider) of the subscriber, and/or the like. Additionally, or alternatively, the system of record may function to collect, store, and/or intelligently facilitate access to data for an integrator. An integrator, as referred to herein, preferably relates to a third-party service provider of a subscriber to the digital threat mitigation service or any other party distinct from a subscriber that may interface with one or more of a subscriber and/or the system of record.

In one or more embodiments, the DMA service may function to collect data from one or more parties and/or services interfacing with the digital threat mitigation service or the like. In such embodiments, the one or more parties may include, but should not be limited to, subscribers to the digital threat mitigation platform and integrators, which may include third-party service providers to the subscribers or to the digital threat mitigation platform. Additionally, or alternatively, data that may be collected, maintained, stored, or otherwise made available by the system of record may include data derived from one or more services and/or operations of the digital threat mitigation platform created during performances of digital threat mitigation services for its subscribers.

### 2.12 API-Based Webhook Launching Conditions

In a preferred embodiment, webhook launching criteria for configuring webhook launching conditions may include parameters and/or criteria for defining API-based calls or requests (e.g., orders, API triggers, etc.) that, when executed by an API service (e.g., the first service) of the system of record or the like, causes an automated execution of one or more distinct webhook operations of a webhook service (e.g., the second service).

In some embodiments, API-based webhook launching criteria may include parameters that define multiple components or parts of an API-based webhook trigger. Each part of the webhook launching criteria, when used to configure an API webhook launching trigger or condition, may function to automatically execute multiple, distinct tasks or services that include, at least, launching one or more designated webhook operations. That is, the webhook launching criteria may define one or more webhook triggers that may be multi-functional triggers that function to cause multiple, distinct automated workflows and/or responsive actions. As an example, a first part or a first task of an API webhook launching trigger, when executed, may function to perform payload creation and a second part or task of the trigger may function to execute a webhook operation. In such example, the first task of the API webhook condition may function to initialize or cause the execution of additional operations, such as for example, data accessing and data payload creation. In some embodiments, the data accessed or the data payload created may be passed together with a webhook identifier or the like to a webhook service (i.e., for executing the second task) for the automated execution of a webhook that delivers the payload to a webhook destination.

Additionally, or alternatively, the API-based webhook launching criteria may function to specify one or more identifier fields that may be required for sourcing data for constructing a webhook payload. For instance, the API-based webhook launching criteria may function to specify a requirement for an event identification parameter, a user identification parameter, and/or any suitable data identification parameter that may be used in the system of record for sourcing relevant data handled by the system of record for building a webhook payload.

In one or more embodiments, identifying a set of webhook launching criteria for creating one or more API call-based webhook launching conditions include receiving, via a web-based console or via a programmatic interface, a plurality of API criteria from a subscriber and/or an integrator to the system of record. In such embodiments, the webhook launching criteria may include one or more of an order or request type, a designated webhook identifier, one or more webhook destinations (e.g., URLs, web applications, etc.), and the like. In these embodiments, the order type may include a customized or standard API-comprehensible characters that causes an API service to access or create a payload with a particular type of data accessible via the system of record.

In one or more embodiments, a subscriber as referred to herein may relate to an online service provider or customer of the digital threat mitigation service (sometimes referred to herein as “threat service”) that implements the system of record. In some embodiments, the online service provider may function to utilize one or more threat mitigation services of the threat service and may function to provide event data of one or more online events for computing a machine learning-based threat score for the one or more online events. In such embodiments, the threat service implementing the system of record may function to maintain or store the event data on behalf of the subscriber. In some embodiments, the service provider may function to perform one or more services for the subscriber and in performing the services may require data resources from the system record and may provide or produce data that may be deposited into the system of record.

### 2.20 Webhook Criteria|Webhook Configuration

S220, which includes identifying criteria for configuring a webhook, may function to obtain criteria that define one or more automated webhook operations and configure the one or more automated webhook operations within or in association with the system of record. In one or more embodiments, the criteria for configuring the one or more automated webhook operations include one or more of an identification of a webhook launching condition, an expected webhook payload, and one or more webhook destinations. It shall be recognized that the criteria for constructing the one or more automated webhook operations may include any suitable parameters for intelligently executing the one or more webhooks operating with the system of record.

In a preferred embodiment, the set of criteria for configuring a webhook includes one or more webhook destinations. In some embodiments, the one or more webhook destinations include identifying HTTP endpoints in the form of one or more universal resource locators (URLs) or the like. In one or more embodiments, the URLs may be associated with one or more web-accessible applications or the like of a subscriber or integrator of the system of record. In such embodiments, the URL of a subject webhook may be associated with a subscriber-defined destination or an integrator-defined destination, which may include a subscriber application or an integrator application. It shall be noted that a webhook destination, in some embodiments, may include a web-based, network-based location, and/or any suitable endpoint at which a specified webhook payload may be deposited or otherwise, transmitted.

Webhook Payload Criteria

Additionally, or alternatively, S220 may function to identify payload criteria that may be set together with the webhook criteria or independently of the webhook criteria.

In a first implementation, S220 may function to create a specified webhook payload based on a set of subscriber and/or integrator-based API criteria. Accordingly, S220 may function to enable subscribers and/or integrators granularity in creating automated downstream flows of data with fewer lookups for a subscriber and/or integrator. Accordingly, in some embodiments, instead of transmitting decision-specific specific (e.g., block, review, allow, etc.) payloads, the granularity may create multiple webhook payload sub-types, which may simplify and/or decrease a minimum required data to create a payload as described in more detail in S230.

In a second implementation, a set of webhook criteria may set or specify a payload type (i.e., an expected payload) for each distinct webhook operation. For example, in one or more embodiments, a plurality of distinct payload types may exist and the webhook operation may be specifically configured to handle a specified payload type.

Additionally, or alternatively, the webhook criteria may include payload formatting requirements that may enable the system of record implementing one or more parts of the method 200 to intelligently format a target payload of data according to requirements or specifications of a target webhook destination.

### 2.30 Configuring an Extensible Webhook Control Data Structure

S230, which includes configuring and/or implementing an extensible webhook control data structure, may function to encode an extensible webhook control data structure that, in use, may function to control an automated creation and/or execution (e.g., automated triggering) of one or more payloads and/or one or more webhook operations within a system of record (e.g., system 100). In a preferred embodiment, S230 may function to configure and/or encode the webhook control data structure based on one or more of webhook launching criteria and webhook operations criteria (as described in S220).

In one or more embodiments, the extensible webhook control data structure may be any suitable data structure or hardware/software device that stores and/or includes mappings between a plurality of webhook launching events and a plurality of webhook operations/destinations and the like. Additionally, or alternatively, the mappings may include a subset of mappings between the plurality of webhook launching events and payload creation tasks. In such embodiments, a reading of the mappings of the webhook control data structure based on an identified webhook launching event may function to cause an automated execution of both a payload creation task and a webhook operation, which may both be mapped to the same webhook launching event within the webhook control data structure.

In one or more embodiments, configuring the extensible webhook control data structure may include setting one or more webhook launching conditions within the webhook control data structure based at least on one or more webhook launching criteria or parameters. In one example, S230 may function to set a webhook launching condition based on establishing or inserting an entry value or a set of characters within the control data structure that represents a webhook launching event that, when received or detected, satisfies the webhook launching condition. Accordingly, for each of a plurality of distinct webhook launching conditions, S230 may function to establish or enumerate a plurality of distinct entries of distinct webhook launching events within the extensible webhook control data structure.

S230 may, additionally, or alternatively, configure the extensible webhook control data structure by setting one or more webhook operations within the webhook control data structure based at least on one or more webhook operations criteria or parameters. In one example, S230 may function to set a target webhook operation based on establishing or inserting an entry value or a set of characters within the webhook control data structure that represent a webhook destination (e.g., a URL) and/or expected webhook payload that satisfies the target webhook operation.

Additionally, or alternatively, S230 may function to configure a nexus between each distinct webhook launching condition and distinct webhook operation. In a first implementation in which the extensible webhook control data structure a reference structure, such as a single reference data table or the like, S230 may function to configure an executional nexus between a webhook launching condition and a webhook operation based on associatively arranging the webhook launching condition and the webhook operation within the extensible webhook control data structure. In this first implementation, S230 may function to arrange the webhook launching condition and the webhook operation in a pairwise fashion or along a same row or a same column of the single reference data table.

In a second implementation, the extensible webhook control data structure includes multiple distinct components, part, or reference structures. In one embodiment, the webhook control data structure may include a first data structure having each of a plurality of distinct webhook launching conditions and a second data structure having each of a plurality of distinct webhook operations. In such embodiment, S230 may function to configure an executional nexus between the multiple distinct components based on configuring the first data structure with a reference pointer for each of the webhook launching conditions, such that when the webhook launching condition is satisfied, the reference pointer may function to point to a webhook operation entry in the second data structure.

Additionally, or alternatively, the extensible webhook control data structure may include a third data structure having a plurality of distinct payload creation tasks. In such embodiments, S230 may function to configure the first data structure with an executional nexus that triggers or causes an automated execution of operations in the second and third data structures. It shall be recognized that in some embodiments the third data structure may be operationally integrated with the second data structure.

### 2.40 Implementing an Extensible Webhook Service & Extensible Webhook Control Data Structure

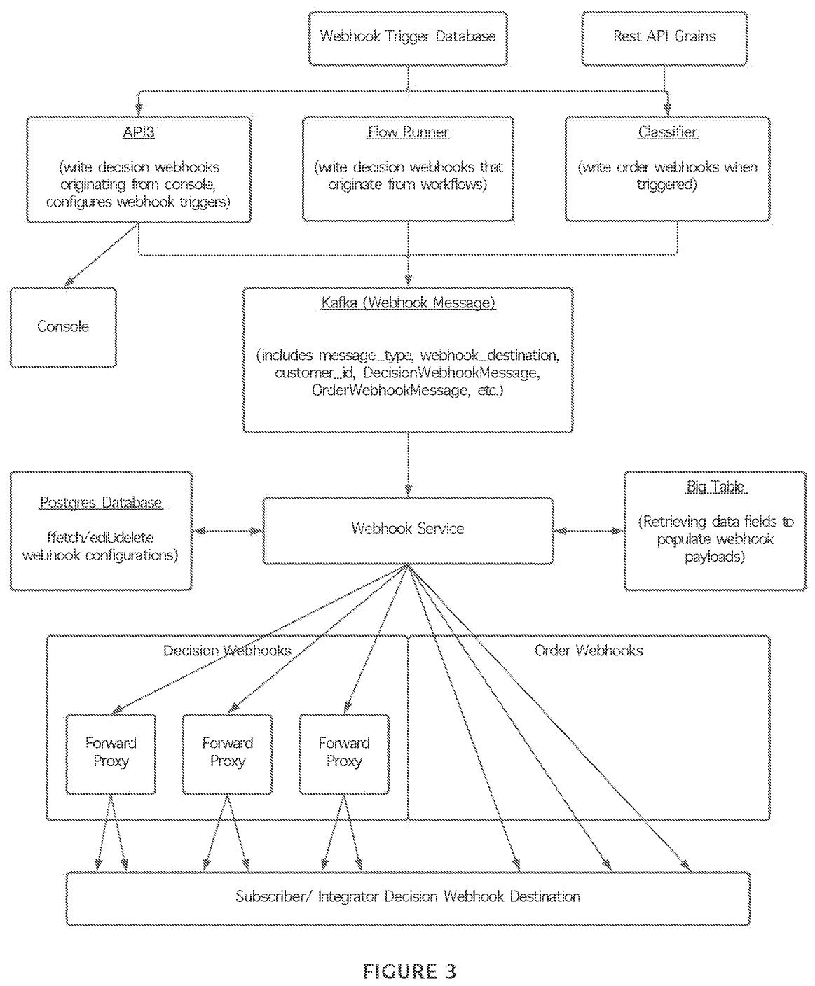

S240, which includes implementing an extensible webhook service, may function to implement a webhook API service encoded with an extensible webhook data structure, as shown by way of example in FIG. 3. In a preferred embodiment, the extensible webhook service may be implemented within a system of record incorporated within a digital threat mitigation service (e.g., system 100) or the like. In such preferred embodiment, one or more of subscribers, integrators (e.g., third-party service providers), and the like to the threat mitigation service may interface with the extensible webhook service for accessing and sourcing data available through the system of record.

In a preferred embodiment, implementing the extensible webhook service may include receiving or identifying a webhook trigger or webhook request. In such preferred embodiment, the webhook trigger may be received via the webhook API service and may include an API request comprising one or more of a webhook trigger identifier and a subscriber or integrator identifier. In some embodiments, the API request may include any suitable data that enables the system of record to locate or identify a desired payload creation task and corresponding webhook destination.

In some embodiments, in response to receiving or identifying the API request, S240 implementing a webhook API service or the like of the system of record may function to map the API request to a webhook launching condition and correspondingly, a webhook operation. That is, S240 may function to interface a webhook request with an extensible webhook control data structure or the like of the extensible webhook service which may allow for a subscriber or integrator to receive a specified webhook payload based on parameters of the webhook request (e.g., a webhook trigger, webhook trigger identifier, etc.). Additionally, or alternatively, S240 may function to map the API request to a corresponding payload creation task that, when executed, creates a data packet that includes data obtained from the system of record.

In one or more embodiments, the mapping may include accessing an extensible webhook control data structure and identifying an associated webhook operation or webhook destination based on a webhook trigger identifier of the API request. In some embodiments, the extensible webhook control data structure additionally includes one or more distinct payload creation tasks, which may be assigned to each distinct webhook trigger or launching condition.

Accordingly, in one or more embodiments, a consumption of an incoming webhook request by the extensible webhook service may cause an automated initialization of a payload creation task. That is, the webhook request may cause the creation of a desired data packet rather than arrive with a data packet that previously created. In such embodiments, the payload creation task may include a set of computer-executable instructions, that when executed by the system of record, causes an automated location, collection, and construction of a data payload in a predetermined format. In some embodiments, the webhook request may include formatting requirements of the data payload/packet.

Additionally, or alternatively, S240 may function to identify a desired webhook destination based on mapping a webhook identifier or the like of the webhook request via the extensible webhook control data structure to one or more webhook destinations. In some embodiments, a construction of a data payload by the system of record and an identification of a webhook destination for the resulting data payload may be performed in a parallel fashion. Accordingly, once the data payload is created by the system of record, S240 may function to automatically transmit the data payload to a target webhook destination based on parameters of the webhook request.

It shall be noted that a webhook request may be created and submitted by either a subscriber to the threat mitigation service or an integrator (e.g., a service provider partner of the threat mitigation service or subscriber). Additionally, or alternatively, while a subscriber or integrator may create a webhook request that enables an automated construction of a payload within the system of record with a webhook destination to one or more applications or services associated with the subscriber or integrator, it shall be known that a subscriber-initiated webhook request or an integrator-initiated webhook request may cause an automated construction of a payload with a webhook destination to a recipient other than themselves. For instance, a subscriber may initiate a webhook request that causes a creation and transmission of a payload to to webhook destination of an integrator (e.g., a payment service provider or the like).

As an example, in a case in which a third-party integrator interfacing with the extensible webhook service, may include a payment service provider of a subscriber responsible for a fraudulent chargeback case type, specialized in chargeback dispute cases, may require data that may not be directly available to the integrator but only available via the subscriber or system of record, which would allow the integrator to definitively resolve a chargeback dispute case. The integrator may request a construction of a unique set of payload packets. As the event webhook triggers, the payload packet will be pushed and written into the integrator specified webhook destination.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

The system and methods of the preferred embodiment and variations thereof can be embodied and/or implemented at least in part as a machine configured to receive a computer-readable medium storing computer-readable instruction. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

We claim:

1. A method for implementing an extensible webhook service that intelligently enables a data management and access service, the method comprising:
receiving, via a web-based configuration interface, API-based webhook criteria for configuring an extensible webhook control data structure within a system of record, wherein the API-based webhook criteria includes:
(1) webhook launching criteria that define one or more conditions for automatically causing an execution of one or more webhook operations; and
(2) webhook operation criteria that define one or more payloads of data desired for one or more webhook destinations;
encoding the extensible webhook control data structure based on the API-based webhook criteria, wherein the encoding includes:
(A) setting a webhook launching condition defining a custom API call that, when received, causes (i) an automatic creation of a payload of data from data sources within a data management and access service and (ii) an execution of a webhook operation; and
(B) setting the webhook operation that identifies a web-based destination for the payload of data and that, when executed, causes an automatic transmission of the payload of data from the data management and access service to the web-based destination;
wherein the extensible webhook control data structure, once encoded, automatically controls an interchange of data between the data management and access service and a plurality of distinct external entities.

2. The method according to claim 1, wherein
the extensible webhook control data structure comprises:
(1) a plurality of distinct webhook launching conditions defined based on a plurality of distinct webhook launching criteria, wherein each of the plurality of distinct webhook launching conditions being enumerated along one of a plurality of distinct entries of the extensible webhook control data structure; and
(2) a plurality of distinct webhook operations defined based on a plurality of distinct webhook operations criteria, wherein each of the plurality of distinct webhook operations being enumerated along one of the plurality of distinct entries in association with one of the plurality of distinct webhook launching conditions.

3. The method according to claim 1, wherein
the webhook launching condition defining the custom API call comprises a unique API parameter that, when received, causes an automatic lookup into the extensible webhook control data structure.

4. The method according to claim 3, wherein
the automatic lookup based on the unique API parameter identifies a target automated webhook workflow that is associated with the unique API parameter within the extensible webhook control data structure.

5. The method according to claim 4, wherein
the automated webhook workflow includes instructions that, when executed, causes:
an automatic creation of the payload of data;
an identification of the webhook destination for the payload of data; and
an automatic transmission of the payload of data to the webhook destination.

6. The method according to claim 1, wherein
the data management and access service comprise:
one or more corpora of data sourced from activities involving the plurality of external entities.

7. The method according to claim 1, wherein
the web-based configuration interface is in operable communication with a webhook service of the data management and access service that creates entries into the extensible webhook control data structure based on the API-based webhook criteria.

8. The method according to claim 1, wherein
the extensible webhook control data structure controls an initialization of a payload service and a webhook service, wherein:
the payload service automatically creates the payload of data and communicates the payload of data to a webhook service, and
the webhook service identifies the webhook destination of the payload of data and automatically transmits the payload of data to the webhook destination.

9. The method according to claim 1, wherein
the extensible webhook control data structure comprises:
a digital mapping between each of a plurality of distinct webhook launching conditions to one of a plurality of distinct payload creation operations and associated one of a plurality of distinct webhook operations.

10. The method according to claim 1, wherein
the encoding the extensible webhook control data structure based on the API- based webhook criteria, wherein the encoding further includes:
establishing an executional nexus between the webhook launching condition and the webhook operation enabling an automated execution of the webhook operation on a basis of satisfying the webhook launching condition.

11. The method according to claim 1, wherein
the webhook control data structure comprises:
a first data structure having each of a plurality of distinct webhook launching conditions, and
a second data structure having each of a plurality of distinct webhook operations.

12. The method according to claim ii, wherein
the encoding the extensible webhook control data structure based on the API- based webhook criteria, wherein the encoding further includes:
configuring an executional nexus between the first data structure and the second data structure, wherein the executional nexus includes a reference pointer that points to an entry in the second data structure based on a satisfaction of a distinct webhook launching condition of the first data structure.

13. The method according to claim 1, wherein
the extensible webhook control data structure, once encoded, controls a webhook API service, wherein the webhook API service is implemented by one or more API computing servers that interface with a plurality of distinct databases of the data management and access service.

14. A method for implementing an extensible webhook service that intelligently enables a system of record, the method comprising:
receiving, via a web-based configuration interface, API-based webhook criteria for configuring an extensible webhook control data structure within a system of record, wherein the API-based webhook criteria includes:
(1) webhook launching criteria that define one or more conditions for automatically causing an execution of one or more webhook operations; and
(2) webhook operation criteria that define one or more payloads of data desired for one or more webhook destinations;
encoding the extensible webhook control data structure based on the API-based webhook criteria, wherein the encoding includes:
(A) setting a webhook launching condition defining a custom API call that, when received, causes (i) an automatic creation of a payload of data from data sources within a system of record and (ii) an execution of a webhook operation; and
(B) setting the webhook operation that identifies a web-based destination for the payload of data and that, when executed, causes an automatic transmission of the payload of data from the system of record to the web-based destination;
wherein the extensible webhook control data structure, once encoded, automatically controls an interchange of data between the system of record and a plurality of distinct external entities.

15. The method according to claim 14, wherein
the extensible webhook control data structure comprises:
(1) a plurality of distinct webhook launching conditions defined based on a plurality of distinct webhook launching criteria, wherein each of the plurality of distinct webhook launching conditions being enumerated along one of a plurality of distinct entries of the extensible webhook control data structure; and
(2) a plurality of distinct webhook operations defined based on a plurality of distinct webhook operations criteria, wherein each of the plurality of distinct webhook operations being enumerated along one of the plurality of distinct entries in association with one of the plurality of distinct webhook launching conditions.

16. A system for implementing an extensible webhook service that intelligently enables a data management and access service of a digital threat mitigation service, the system comprising:
web-based configuration interface that receives API-based webhook criteria for configuring an extensible webhook control data structure within a system of record, wherein the API-based webhook criteria includes:
(2) webhook launching criteria that define one or more conditions for automatically causing an execution of one or more webhook operations; and
(2) webhook operation criteria that define one or more payloads of data desired for one or more webhook destinations;
an extensible webhook service, implement by one or more computers, that encodes the extensible webhook control data structure based on the API-based webhook criteria, wherein the encoding includes:
(A) setting a webhook launching condition defining a custom API call that, when received, causes (i) an automatic creation of a payload of data from data sources within a data management and access service and (ii) an execution of a webhook operation; and
(B) setting the webhook operation that identifies a web-based destination for the payload of data and that, when executed, causes an automatic transmission of the payload of data from the data management and access service to the web-based destination;
wherein the extensible webhook control data structure, once encoded, automatically controls an interchange of data between the data management and access service and a plurality of distinct external entities.

17. The system according to claim 16, wherein
the extensible webhook control data structure comprises:
(1) a plurality of distinct webhook launching conditions defined based on a plurality of distinct webhook launching criteria, wherein each of the plurality of distinct webhook launching conditions being enumerated along one of a plurality of distinct entries of the extensible webhook control data structure; and
(2) a plurality of distinct webhook operations defined based on a plurality of distinct webhook operations criteria, wherein each of the plurality of distinct webhook operations being enumerated along one of the plurality of distinct entries in association with one of the plurality of distinct webhook launching conditions.
